(19) United States
(12) Patent Application Publication
(10) Pub. No.: US 2019/0188302 A1
(43) Pub. Date: Jun. 20, 2019

(54) GROUP-BY-TIME OPERATIONS WITH RETURNED TIME CONTEXT

(71) Applicants: Gregory Howard Milby, San Marcos, CA (US); Richard Charucki, Temecula, CA (US)

(72) Inventors: Gregory Howard Milby, San Marcos, CA (US); Richard Charucki, Temecula, CA (US)

(21) Appl. No.: 15/848,558

(22) Filed: Dec. 20, 2017

(51) Int. Cl. G06F 17/30

(52) U.S. Cl. CPC G06F 17/30528; G06F 17/30554; G06F 17/30598; G06F 17/30592

(57) ABSTRACT

A Data Manipulation Language (DML) syntax is extended for identifying a group-by-time-based operation based on a user-defined time series. The underlying database processing is extended for identifying the time-based operation and generating instructions for processing a query having the time-based operation against the database and providing time-context in query results for the query.

### BACKGROUND

Most database vendors provide support (in Data Manipulation Language (DML) syntax) for group-by aggregate data functionality within the underlying databases. The group-by aggregate operations are processed against dynamically grouped data sets. For example, DML query can define the aggregate groupings for country codes associated with countries. Other aspects of the DML query can derive aggregate information for each individual country identified by country code.

However, there is little support for performing aggregate functions on time-series data sets. The functionality that is provided includes no ability to develop queries in which context for grouped time series data can be returned. Consequently, users must plan and include native information within their datasets that support user-defined time-based context, which in many cases cannot be accomplished by the user due to the effort associated with integrating such information into existing legacy data sets. Moreover, such approaches are static and limited to what the user thought would be useful in the data; however, over time other useful information may prove more valuable to the user.

Therefore, there is a need to provide processing for aggregate time based operations that can return time context with queries.

### SUMMARY

In various embodiments, group-by-time operations with returned time context is presented.

In an embodiment, a method for processing group-by-time operations with returned time context is provided. A group-by-time clause with a time/date interval is identified in a query. Next, a column is obtained having a time/date data type to process with the group-by-time clause from the query. Query instructions are generated for grouping data associated with the column into buckets of the time/date interval and for processing other conditions defined in the query. Finally, the query instructions are processed producing query results for the query having time/date context.

### BRIEF DESCRIPTION OF THE DRAWINGS

FIG. 1A is a diagram of a system for group-by-time operations with returned time context, according to an embodiment.

FIG. 1B is a diagram illustrating an example group-by-time query with returned time context, according to an example embodiment.

FIG. 2 is a diagram of a method for processing group-by-time operations with returned time context, according to an example embodiment.

FIG. 3 is a diagram of another method for processing group-by-time operations with returned time context, according to an example embodiment.

FIG. 4 is a diagram of another system for group-by-time operations with returned time context, according to an example embodiment.

### DETAILED DESCRIPTION

Various embodiments depicted herein are implemented as one or more software modules, which are programmed within memory and/or non-transitory computer-readable storage media and executed on one or more processing devices (having memory, storage, network connections, one or more processors, etc.).

As used herein, the terms and phrases “database,” and “data warehouse” may be used interchangeably and synonymously. That is, a data warehouse may be viewed as a collection of databases or a collection of data from diverse and different data sources that provides a centralized access and federated view of the data from the different data sources through the data warehouse (may be referred to as just “warehouse”).

A novel and new database processing technique is provided for processing group-by-time aggregate data operations with returned time context. The native data tables (data sets) include at least one data type that is a time data type and/or a date data type. The processing recognizes two new time-based operations from a DML query and generates on-the-fly or dynamically two additional columns that are linkable to the native data tables based on the DML query defined by the user.

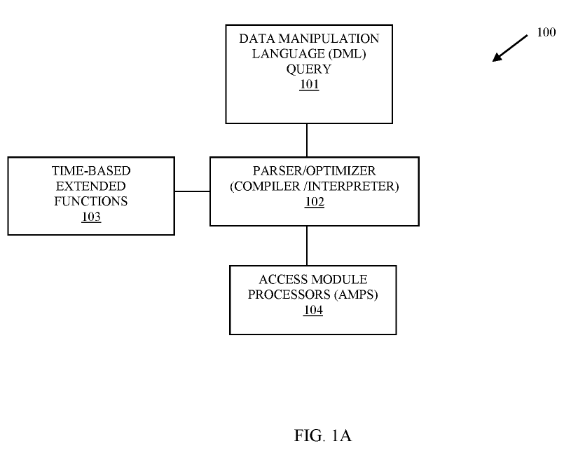

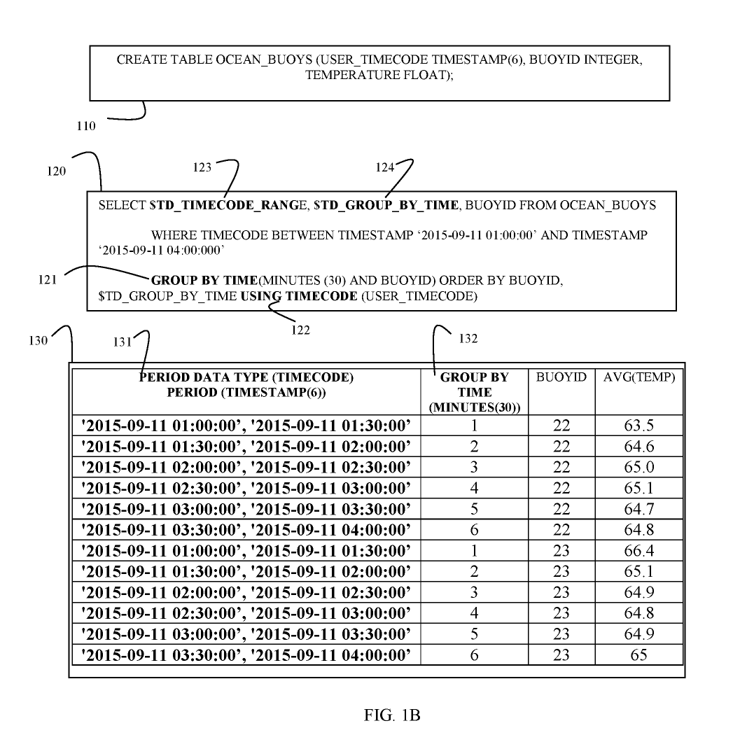

FIG. 1A is a diagram of a system 100 for processing group-by-time operations with returned time context, according to an embodiment.

The system 100 is shown in greatly simplified form with just those components necessary for comprehension of embodiments of the invention presented. It is to be understood that additional components or subcomponents may be used without departing from the teachings presented herein.

The system 100 includes a Data Manipulation Language (DML) (such as Structured Query Language (SQL)) query 101 (herein after just “query 101,” a parser/optimizer (compiler/interpreter) 102 (herein after just “parser 102”), time-based extended functions 103, and Access Module Processors 104 (AMPs—that execute instructions against the database, the database execution engine).

The query 101 can be issued and/or originate from an automated process (application or script) within the warehouse/database (such as through schedule reports, etc.) or can be issued and/or originate from an end-user (such as a Database Administrator (DBA) or Data Analyst) through a user-interface to the warehouse/database.

Two new DML operations are supported in the query 100 that are identified by the phrases/clauses “Group By Time” and “Using Time Code.” In an embodiment, the DML is Structured Query Language (SQL); although it is to be noted that any DML can be used without departing from the SQL-based example processing scenarios discussed herein. Furthermore, the names/labels of the new DML operations can be different from what is described without departing from the teachings presented herein. For example, Group By Time may be GBT and Using Timecode may be UT. Any two newly reserved DML operations that perform the functionality of the Group By Time and Using Timecode operations, as presented herein and below, can be used without departing from the various embodiments presented herein.

In addition, two new column name/labels 123 and 124 for any user-defined database table may be referenced in the query 101. These two new column names reference 123 and 124 (from within a user-defined query 101) two dynamically generated and linked time-based columns 131 and 132 for the database table in a results table 130 providing results for the query 101 or 120. The two new columns 131 and 132 may be considered to be virtual columns because they are not defined and not physically present in the user-defined table; rather, the two new virtual columns 131 and 132 are generated dynamically when the query 101 is executed by the parser 102 and/or AMPs 104 and presented in the query results table 130. In an embodiment, the two new column names 123 and 124 provided for referencing the two virtual and dynamically created columns 131 and 132 are: 1) $TD_TIMECODE_RANGE 123 references a virtual column 131 that is dynamically created and has a default title of “TIMECODE RANGE” (in a presented version of the results table 130) and is linked to the database table through a query results table 130, and 2) $TD_GROUP_BY_TIME 124 reverences a virtual column 132 and has a default title of “GROUP BY TIME” (in a presented version of the results table 130) and is linked to the database table that the query results table 130. Again, the syntax for the two virtually created and linked table references 123 and 124 can vary without departing from the teachings presented herein. The name references 123 and 124 corresponding to the actual column names for the virtual columns 131 and 132, respective.

Initially, a user creates a table having a data type that is a timestamp data type or a date data type. A sample of DML syntax for defining and creating an initial user table in the database is provided as the block of SQL statements 110 in the FIG. 1B. The table created is OCEAN_BUOYS and includes three columns of data: 1) USER_TIMECODE of data type TIMESTAMP (having a precision of 6 digits following the integer portion of the time (a precision of 6 permits data as small as milliseconds), 2) BUOYID of data type Integer, and TEMPERATURE of data type Float. Subsequent to the user initially creating the table, operations are performed to populate the columns of the table with actual data values (not shown in the FIG. 1B).

Once the data is populated and available in the user-created table, the user defines a query 120 (in the FIG. 1B) in SQL syntax where the virtual column 131 is referenced with the name of $TD_TIMECODE_RANGE 123 (corresponding directly to virtual column 131 and having a default presented title of TIMECODE RANGE in the results table 130), and where the virtual column 132 is referenced with the name of $TD_GROUP_BY_TIME 124 (corresponding direct to the virtual column 132 and having the default presented title of GROUP BY TIME in the results table 130). Again, the columns $TD_TIMECODE_RANGE 131 and $TD_GROUP_BY_TIME 132 were not included in the user created table statements of 110 and the data associated with those columns did not exists when the table (OCEAN_BUOYS) was created and subsequently populated with actual data values. The user's query 120 also references the time-based operation GROUP BY TIME 121 and USING TIMECODE 122. The GROUP BY TIME operation 121 takes as input a time interval (time period) and a column identifier (BUOYID in the example query 120) from the original table (OCEAN_BUOYS) that is being aggregated based on the time period. The GROUP BY TIME operation 121 can also be ordered by BUOYID and $TD_GROUP_BY_TIME 124 (the name reference label to virtual column 132) following the statement “ORDERED BY BUOYID” that follows the input parameters to the GROUP BY TIME operation 121. The USING TIMECODE operation 122 takes as an input parameter the time and/or date-based data type that the user originally defined when the OCEAN_BUOYS table was created, in the example the column USER_TIMECODE is passed as the input parameter to the USING TIMECODE operation 122.

The parser 102 parses the query 120 and identifies the syntax and structure of the query elements (predicates, columns, tables, operations, variables, constants, etc.). The parser 102 then generates instructions or a plan for the AMPS 104 to execute against the database and the table 130 to return results for the query 120. When the parser 102 recognizes the syntax for references (names of $TD_TIMECODE_RANGE 123 and $TD_GROUP_BY_TIME 124, which correspond to virtual column 131 and 132, respectively) along with the operations GROUP BY TIME 121 and USING TIMECODE 122. The parser 102 calls the time-based extended functions 103 to provide the instructions for those portions of the query 120. The time-based extended functions 103 recognizes the input parameter to the function Group By Time 121 that is associated with the time period (in the example the time period was set to 30 minutes by the MINUTES(30) operation). The original table (OCEAN_BUOYS) includes a timestamp data type set to 6 levels of precision (milliseconds). The instructions produced by the time-based extended functions 103 aggregates the USER_TIMECODE data populated in the OCEAN_BUOYS table into time periods or intervals of 30 minutes by unique BUOYID data housed in BUOYID column. Each period of 30 minutes is identified through the USING TIMECODE (USER_TIMECODE) operation 122.

The parser 102 provides the instructions for executing the query 120 to the AMPS 140 and the AMPS 140 return a results table 130 (shown in the FIG. 1B). The results table 130 includes the virtually created $TD_TIMECODE_RANGE column 131 (identified by the label TIMECODE RANGE) as the unique time periods or intervals and the query results table 130 includes the virtually created $TD_GROUP_BY_TIME column 132 (identified by the label GROUP BY TIME) along with averaged temperatures per unique time interval by unique buoy id (ordered in the manner defined by the query 120).

The time-based extended functions 103 takes the time interval provided by the user in the query 120 (MINUTES(30)) and generates instructions for grouping the user's USER_TIMECODE (time or date data type) into buckets defined by the time interval supplied in the query 120. The grouping of the data from the OCEAN_BUOYS table can then be used in an intermediate and runtime table for processing other conditions of the query 120. The results table 130 then includes the two dynamic and virtual columns 131 and 132, which did not exist and which were not present original in the user-created OCEAN_BUOYS table. The dynamically created columns 131 and 132 provide time context for the user's query 120 in the results table 130 when the query 120 is executed by the AMPs 104 (database engine) against the database.

The system 100 provides aggregated group-by-time operations that return time context in a results table 130 for a query 101 and/or 120. The time-based context includes at least two new virtually created columns 131 and 132 that were not part of the original user-defined data table and that were automatically generated and linked with the original defined data table in the results table 130.

It is noted that the example query 120 was presented for purposes of illustration and the query 101 can be more complex and can involve more than a single table. The only requirement is that at least one table in the query have a data type is time based or date based. It is also noted that depending upon the underlying database more specific and custom time-based or date-based data types may be used.

Furthermore, the time-based extended functions 103 are configured to support the underlying database's time and date data types and recognize logical intervals or periods in those data types for purposes of generating the instructions to execute the query 101 and organize the time or date data types into buckets based on the user-defined time period or interval.

Thus, the time-based extended functions 103 generate query instructions for executing a time/date series aggregate identified by the Group By Time operation 121 and provides time context with the dynamically generated columns 131 and 132 in the results table 130 for the query 120.

The Group By Time operation 121 (identified by the DML clause or phrase in the query 101) is defined as: Group By Time(duration_spec [AND ‘additional_column_list’]). The Using Timecode operation 122 (identified by the DML clause or phrase in the query 101) is defined as: Using Timecode(user-time-or-date column [optionally user-defined-sequence-number-column]). Duration_spec is a user-provided query parameter that specifies a duration/time interval/time period that is to be dynamically generated from the user-time-or-date column (the column in the user's table having a time-based or date-based data type). The additional_column_list is an optional user-provided parameter that the user desires to become a part of the Group By Time aggregate function/operation 121. The user-time-or-date column is the name of the column from the user's table that includes a time-based or date-based data type being processed to generate the time series. The user-defined-sequence-number-column is a user-provided parameter that identifies a name of any optional sequence number column that can be used in conjunction with the user-time-or-date column for establishing the time/sequence order of the time series.

The reference labels (names used in the query 120) 123 and 124 reference the virtually created columns 131 and 132 have common properties in that: 1) there is no requirement that these column names be listed within the Group By Time clause 121, and 2) a default returned label for these columns 131 and 132 is TIMECODE RANGE for 131 and Group By Time for 132. These titles/labels provided in the columns 131 and 132 can be custom-defined by the user in the query 101 using the SQL “AS” clause. Additionally, the reference name labels 123 and 124 can be utilized by the user within the query 101 anywhere that a traditional column reference (column name) can be logically referenced within the query 101 (the labels 123 and 124 are the names and syntax for the virtual columns 131 and 132, respectively). Thus, these names 123 and 124 can be directly referenced by existing underlying database functions and/or passed into User-Defined Functions (UDFs). The names 123 and 124 can also be referenced within the Order By SQL clause for purposes of ordering the output in the results table 130 (for example, SELECT BEGIN ($TD_TIMECODE_RANGE), END($TD_TIMECODE_RANGE).

The label reference (name) 123 references the virtual column 131 and is a PERIOD data type whose element type is the same as the data type associated with the query 101. So, in the example query 120, the USER_TIMECODE in the OCEAN_BUOYS table is a timestamp data type, which means that the virtual column 131 is a timestamp data type and that the name 123 references a timestamp data type. If the user would have defined the USER_TIMECODE in the OCEAN_BUOYS table to be a DATE data type, then the name 123 references the virtual column 131 as a DATE data type.

The label reference (name) 124 references the virtual column 132 as an Integer data type.

Once the parser 102 in cooperation with the time-based extended functions 103 produce executable instructions for executing the query 101 by AMPs 104 of the database. When the instructions are processed by the AMPs 104, the results table 130 is produced having the dynamically generated virtual columns 131 and 132 providing aggregate data operations with time-based context.

It is also noted that the query 101 can be user-defined to join aggregated data from different time series involving multiple tables. Furthermore, time series can be aggregated. As previously stated, the queries 101 can be as complex as the user desires to provide the appropriate data aggregation with time context(s).

In an embodiment, the time-based extended functions 103 are subsumed as enhancements into the parser 102 as a single enhanced parser 102.

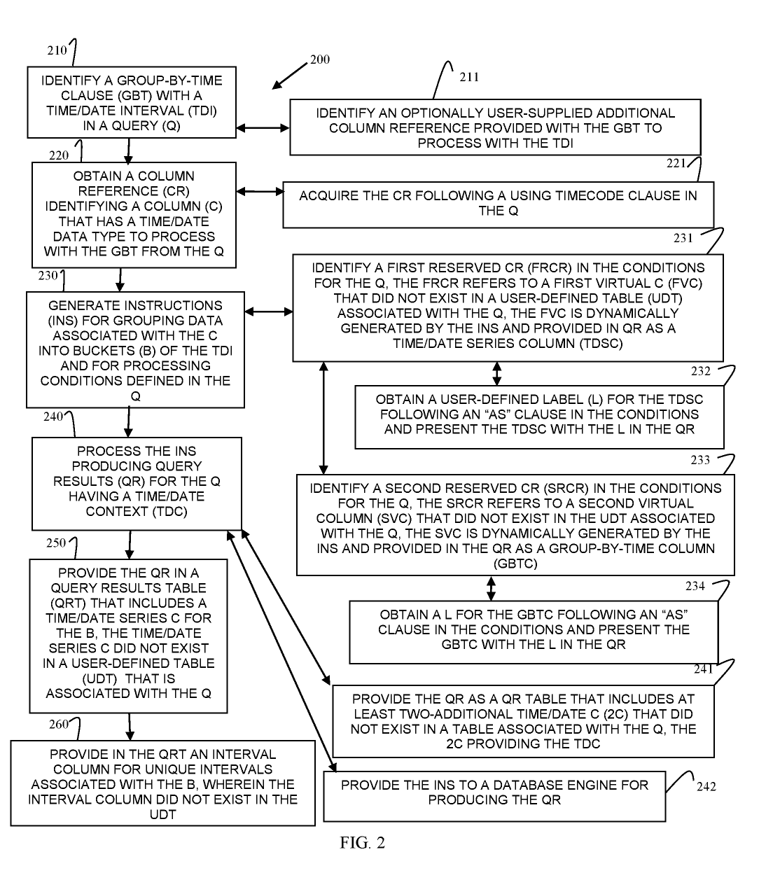

These and other embodiments are now discussed with the FIGS. 2-4.

FIG. 2 is a diagram of a method 200 for processing group-by-time operations with returned time context, according to an example embodiment. The method 200 is implemented as one or more software modules referred to as a “query time-context controller”). The query time-context controller is executable instructions that are programmed within memory or a non-transitory computer-readable medium and executed by one or more hardware processors. The query time-context controller has access to one or more network connections during processing, which can be wired, wireless, or a combination of wired and wireless.

In an embodiment, the query time-context controller is implemented within a data warehouse across one or more physical devices or nodes (computing devices) for execution over a network connection.

In an embodiment, the query time-context controller includes the parser 102 and the time-based extended functions. That is, the query time-context controller performs, inter alia, the processing as discussed above with the FIGS. 1A and 1B.

At 210, the query time-context controller identifies a group-by-time clause with a time/date interval in a query that is provided for processing against a database. Such a group-by-time clause was described at length above with the discussion of the FIGS. 1A and 1B.

In an embodiment, at 211, the query time-context controller identifies an optionally user-supplied additional column reference provided with the group-by-time clause to process with the time/date interval. These optional columns were discussed above with the example query 120 and the discussions of the FIGS. 1A and 1B.

At 220, the query time-context controller obtains a column reference that identifies a column having a time/date data type to process with the group-by-time clause from the query.

In an embodiment, at 221, the query time-context controller acquires the column reference following a use timecode clause in the query. The usage of the use timecode clause and the processing associated with that clause was discussed at length above with the discussions of the FIGS. 1A and 1B.

At 230, the query time-context controller generates instructions for grouping data associated with the column into buckets (groupings associated with a time series) of the time/date interval and for processing other conditions defined in or with the query.

According to an embodiment, at 231, identifies a first reserved column reference in the other conditions for the query. The first reserved column reference refers to a first virtual table that did not exist in a user-defined table associated with the query. The first virtual table is dynamically generated by the instructions and provided in the query results as a time/date series column. That is, the first virtual table is non-existent when the query references it with the first reserved column reference.

In an embodiment of 231 and at 232, the query time-context controller obtains a user-defined label for the time/date series column following an “AS” clause in the other conditions, and the instructions when processed present the time/date series column with the user-defined label in the query results.

In an embodiment of 231 and at 233, the query time-context controller identifies a second reserved column reference in the other conditions for the query. The second reserved column references refers to a second virtual column that did not exist in the user-defined table associated with the query and that was non-existent when referenced in the query. The second virtual column is dynamically generated by the instructions and provided in the query results as a group-by-time column.

In an embodiment of 233 and at 234, the query time-context controller obtains a user-defined label for the group-by-time column following an “AS” clause in the other conditions of the query, and the instructions when processed present the group-by-time column with the user-defined label in the query results.

The processing discussed at 231-234 was also discussed above with reference to the FIGS. 1A and 1B.

At 240, the query time-context controller processes the instructions producing query results for the query and the query results include a time-date context.

In an embodiment, at 241 the query time-context controller provides the query results as a query results table that includes at least two-additional time/date columns that did not exist in a table associated with the query. The two additional time/date columns provide the time/date context in the query results.

In an embodiment, at 242, the query time-context controller provides the instructions to a database engine for producing the query results. For example, one or more of the AMPs 104 discussed above with the FIGS. 1A and 1B.

According to an embodiment, at 250, the query time-context controller provides the query results in a query results table that includes a time/date series column for the buckets (groupings). The time/date series column did not exist in a user-defined table that is associated with the query. It may be referenced within the query as discussed at 231 but was non-existent at the time of the query and is generated when the instructions for the query are processed against the database.

In an embodiment of 250 and at 260, the query time-context controller provides in the query results table an interval column for unique intervals associated with the buckets (groupings based on time/date and defined by the time/date interval). Again, the time/date series column did not exist in the user-defined table that is associated with the query (was no existent until produced and generated when the instructions are processed). The interval column may still be referenced within the query as discussed at 233.

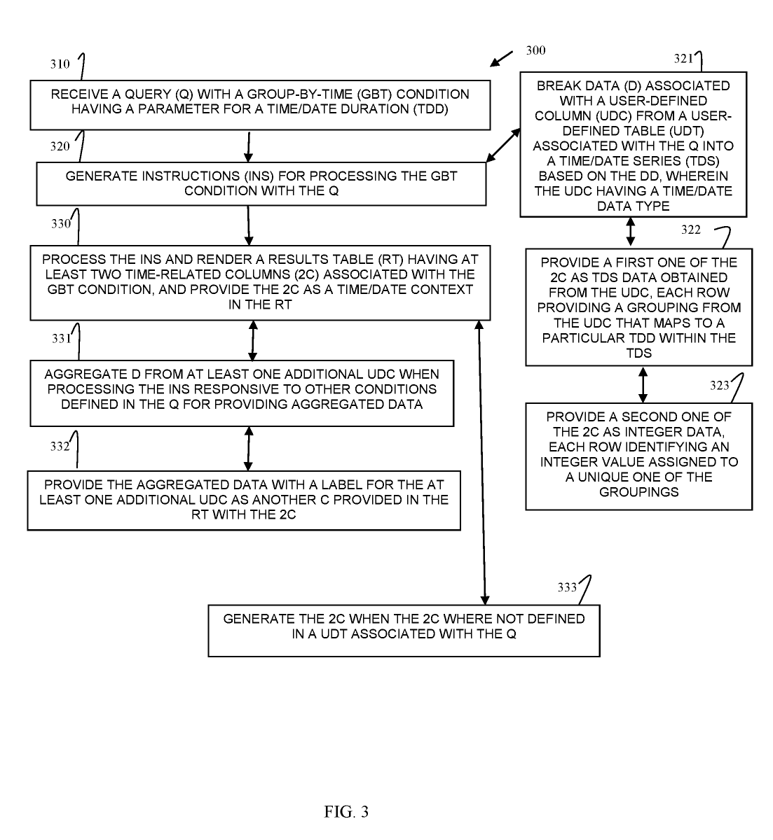

FIG. 3 is a diagram of another method 300 for processing group-by-time operations with returned time context. The method 300 is implemented as one or more software modules referred to as a “time-context query manager.” The time-context query manager is executable instructions that are programmed within memory or a non-transitory computer-readable medium and executed by one or more hardware processors. The time-context query manager has access to one or more network connections during processing, which can be wired, wireless, or a combination of wired and wireless.

The time-context query manager presents another and in some ways enhanced perspective of the processing discussed above with the FIGS. 1A-1B and 2.

In an embodiment, the time-context query manager is all or some combination of: the parser 102, the time-based extended functions 103, and/or the method 200.

At 310, the time-context query manager receives a query with a group-by-time condition having a parameter for a time/date duration.

At 320, the time-context query manager generates instructions for processing the group-by-time condition with the query.

In an embodiment, at 321, the time-context query manager breaks the data associated with a user-defined column from a user-defined table associated with the query into a time/date series based on the time/date duration. The user-defined column having a time/date data type.

In an embodiment of 321 and at 322, the time-context query manager provides a first one of the at least two time-related columns (discussed at 330) as time/date series data obtained from the user-defined column. Each row providing a grouping from the user-defined column that maps to a particular time/data duration within the time/date series.

In an embodiment of 322 at 323, the time-context query manager provides a second one of the at least two time-related columns (discussed at 33) as integer data. Each row identifying an integer value assigned to a unique one of the groupings.

At 330, the time-context query manager processes instructions and renders a results table having the at least two time-related columns associated with the group-by-time condition. The two time-related columns as a time/date context for the query in the results table.

In an embodiment, at 331, the time-context query manager aggregates data from at least one additional user-defined column when processing the instructions that is responsive to other conditions defined in the query for providing aggregated data.

In an embodiment of 331 and at 332, the time-context query manager provides the aggregated data with a label for the additional column as another column provided in the results table with the two time-related columns.

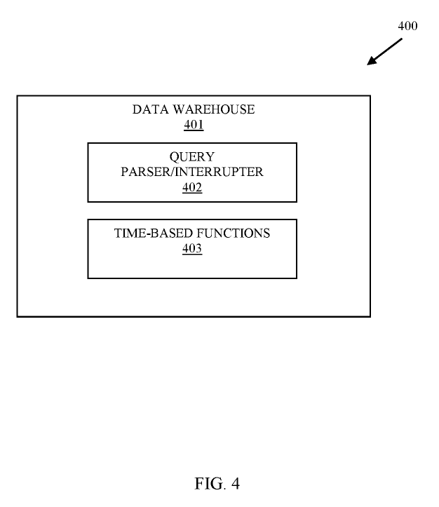

FIG. 4 is a diagram of another system 400 processing group-by-time operations with returned time context, according to an embodiment. The system 400 includes a variety of hardware components and software components. The software components are programmed as executable instructions into memory or a non-transitory computer-readable medium for execution on the hardware components.

The system 400 implements, inter alia, the processing discussed above with the FIGS. 1A-1B and 2-3.

The system 400 includes a data warehouse 401. The data warehouse 401 includes query parser/interrupter 402 (herein after just “parser 402”) and time-based functions 403.

In an embodiment, the parser 402 is the parser 102.

In an embodiment, the time-based functions 402 are the time-based extended functions 103.

In an embodiment, the parser 402 and the time-based functions 403 are all or some combination of the method 200 and/or the method 300.

The parser 402 is configured to: 1) execute on at least one hardware processor of a network computing device, 2) identify group-by-time clauses in a query, iii) access the time-based functions 403 with conditions and parameters associated with the group-by-time clauses, iv) receive time-based instructions as output from the time-based functions 403, v) generate query instructions for the query including the time-based instructions, and vi) provide the query instructions to a data warehouse engine for executing the query against the data warehouse 4-1.

In an embodiment, the data warehouse engine is configured to present at least two time/date columns of data in a results table in response to processing the query instructions, wherein the at least two time/date columns providing a time/date context, and wherein the at least two time/date columns were not present in a user-defined table associated with the query and are generated when the instructions are processed.

The time-based functions 403 is configured to: 1) execute on the at least one hardware processor of the network computing device and 2) produce the time-based instructions based on the group-by-time clause and the associated conditions and parameters received from the query parser 402.

In an embodiment, the time-based functions 403 is subsumed into the query parser 402, such that the query parser 402 is one module processing as an enhanced parser query 402 providing group-by-time operations with returned time/date context when query is processed against the data warehouse 401 by the data warehouse engine.

In an embodiment, the data warehouse engine is one or more of the AMPs 104.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

1. A method, comprising:
identifying a group-by-time clause with a time/date interval in a query;
obtaining a column reference identifying a column that has a time/date data type to process with the group-by-time clause from the query;
generating instructions for grouping data associated with the column into buckets of the time/date interval and for processing conditions defined in the query; and
processing the instructions producing query results for the query having a time/date context.

2. The method of claim 1 further comprising, providing the query results in a query results table that includes a time/date series column for the buckets, wherein the time/date series column did not exist in a user-defined table that is associated with the query.

3. The method of claim 2 further comprising, providing in the query results table an interval column for unique intervals associated with the buckets, wherein the interval column did not exist in the user-defined table.

4. The method of claim 1, wherein identifying further includes identifying an optionally user-supplied additional column reference provided with the group-by-time clause to process with the time/date interval.

5. The method of claim 1, wherein obtaining further includes acquiring the column reference following a using timecode clause in the query.

6. The method of claim 1, wherein generating further includes identifying a first reserved column reference in the conditions for the query, wherein the first reserved column reference refers to a first virtual column that did not exist in a user-defined table associated with the query, wherein the first virtual column is dynamically generated by the instructions and provided in the query results as a time/date series column.

7. The method of claim 6, wherein generating further includes obtaining a user-defined label for the time/date series column following an “AS” clause in the conditions and presenting the time/date series column with the user-defined label in the query results.

8. The method of claim 6, wherein generating further includes identifying a second reserved column reference in the conditions for the query, wherein the second reserved column reference refers to a second virtual column that did not exist in the user-defined table associated with the query, wherein the second virtual column is dynamically generated by the instructions and provided in the query results as a group-by-time column.

9. The method of claim 8, wherein generating further includes obtaining a user-defined label for the group-by-time column following an “AS” clause in the conditions and presenting the group-by-time column with the user-defined label in the query results.

10. The method of claim 1, wherein processing further includes providing the query results as a query results table that includes at least two-additional time/date columns that did not exist in a table associated with the query, wherein the at least two-additional time/date columns providing the time/date context.

11. The method of claim 1, wherein processing further includes providing the instructions to a database engine for producing the query results.

12. A method, comprising:
receiving a query with a group-by-time condition having a parameter for a time/date duration;
generating instructions for processing the group-by-time condition with the query; and
processing the instructions and rendering a results table having at least two time-related columns associated with the group-by time condition, and providing the at least two time-related columns as a time/date context in the results table.

13. The method of claim 12, wherein generating further includes breaking data associated with a user-defined column from a user-defined table associated with the query into a time/date series based on the time/date duration, wherein the user-defined column having a time/date data type.

14. The method of claim 13, wherein processing further includes providing a first one of the at least two time-related columns as time/date series data obtained from the user-defined column, each row providing a grouping from the user-defined column that maps to a particular time/date duration within the time/date series.

15. The method of claim 14, wherein processing further includes providing a second one of the at least two time-related columns as integer data, each row identifying an integer value assigned to a unique one of the groupings.

16. The method of claim 15, wherein processing further includes aggregating data from at least one additional user-defined column when processing the instructions responsive to other conditions defined in the query for providing aggregated data.

17. The method of claim 16, wherein aggregating further includes providing the aggregated data with a label for the at least one additional user-defined column as another column provided in the results table with the at least two time-related columns.

18. The method of claim 12, wherein processing further includes generating the at least two time-related columns when the at least two time-related columns where not defined in a user-defined table associated with the query.

19. A system, comprising:
a data warehouse including:
a query parser; and
time-based functions;
wherein the query parser is configured to i) execute on at least one hardware processor of a network computing device, ii) identify group-by-time clauses in a query, iii) access the time-based functions with conditions and parameters associated with the group-by-time clauses, iv) receive time-based instructions as output from the time-based functions, v) generate query instructions for the query including the time-based instructions, and vi) provide the query instructions to a data warehouse engine for executing the query against the data warehouse.

20. The system of claim 19, wherein the data warehouse engine is configured to present at least two time/date columns of data in a results table in response to processing the query instructions, wherein the at least two time/date columns providing a time/date context, and wherein the at least two time/date columns were not present in a user-defined table associated with the query and are generated when the instructions are processed.
